(19) United States
(12) Patent Application Publication
(10) Pub. No.: US 2013/0268308 A1
(43) Pub. Date: Oct. 10, 2013

(54) DISTRIBUTED SOFTWARE FRAMEWORK FOR DEFINING AND MANAGING GEO-TASK CAMPAIGNS

(71) Applicants: Thomas D. Erickson, Minneapolis, MN (US); Loren Terveen, Minneapolis, MN (US)

(72) Inventors: Thomas D. Erickson, Minneapolis, MN (US); Loren Terveen, Minneapolis, MN (US)

(73) Assignee: INTERNATIONAL BUSINESS MACHINES CORPORATION, Armonk, NY (US)

(21) Appl. No.: 13/440,460

(22) Filed: Apr. 5, 2012

(51) Int. Cl. G06Q 10/06

(52) U.S. Cl. 705/7.13

(57) ABSTRACT

Defining and managing geo-task campaigns, in one aspect, may include enabling a creator of a campaign to define a collective data-gathering activity to be carried out by a plurality of participating respondents, the collective data-gathering activity defined at least by geographic location, time period and activity. One or more response values may be received from the plurality of participating respondents, the response values including data that conforms to the defined collective data-gathering activity including a description of the geographic location, a description of the time period, a description of one or more objects at the location associated with the activity. Response values are coordinated according to the defined geographic location, time period and activity.

### FIELD

The present application relates generally to computers, and computer applications, and more particularly to defining and managing geo-tasks.

### BACKGROUND

Geo-tasks are human-mediated tasks that involve going to a specified area or location or set of locations in the physical world, performing actions, at least one that affects some aspect of the physical environment, recording the results, and making those results available to others. Geo-tasks require human intelligence and human action to be completed. An example of a geo-task may include taking a reading of a level of an environmental pollutant like ozone, assessing a tree to determine whether it has Dutch Elm disease, or inspecting an artifact like a fire hydrant to see whether it is usable.

Typically geo-tasks are performed and recorded using a networked mobile device (e.g., a smart phone), and may involve a human making a judgment, and/or using a sensor to take a reading. In this case, the sensing and recording will be done using the device (e.g., by taking a photo or filling out a form or using a custom-built application) and the results will be submitted over the network in near real time. However, in some cases, the applicants in the present disclosure have recognized that it will be necessary or desirable for the sensing to be done without technological assistance (e.g., in a remote rural area where there is no cell phone coverage and no way to charge electronic devices) and the results entered later.

It is often the case that to address a real world problem many instances of the same geo-task need to be performed during a certain time period and across a particular geographic region or across many regions. The present disclosure herein will refer to an effort to ensure the performance of such a coordinated set of geo-task instances as a campaign. Because geo-tasks are human mediated, carrying out a geo-task campaign requires the orchestration of many people. Such orchestration may include activities like soliciting, signing up, training, coordinating and incenting participants. Orchestrating a geo-task campaign is a non-trivial problem.

Known systems such as participatory sensing systems in the domains of citizen science and open government allow ordinary people to collect data using mobile devices. One well known example is See-Click-Fix, a commercial system which allows people to report potholes and other street problems, which are then displayed on a public map. Another system is GreenWatch, which allows inhabitants to collect and report readings of noise and ozone levels in city streets. A third system is CreekWatch, which enables users to report the state—water level, presence of trash, etc.—of waterways, and to submit a photo. None of these systems, however, addresses the issue of creating a particular campaign, or orchestrating potential participants in the campaign.

Known systems allow the orchestration of many people to carry out human computation tasks. Human Computation Orchestration includes Amazon™'s “Mechanical Turk”, a human computation” infrastructure. It allows for the definition of “human intelligence tasks”, small units of work that can be completed by individuals, for which the individuals receive financial compensation, typically from $0.05 to $0.10 (USD). A number of other such systems enable human computation via cell phones. txteagle (txteagle dot com), for example, distributes tasks to mobile phone users in developing countries. None of these systems affords the orchestration of people involved in carrying out geo-tasks.

Online organization of collocated activities aims to facilitate geographically localized activities. The leading system in this area is MeetUp. MeetUp facilitates the online organization of face-to-face activities open to the general public (e.g., book club gatherings, museum visits or pub crawls) by allowing organizers to post messages describing the time, place and nature of the meeting. While MeetUp and similar systems support geographically localized activities, the activities are unstructured and centralized—they do not involve what the present disclosure refers to as geo-tasks—and they produce no data; furthermore, the systems which support such collocated activities are simple messaging systems that provide no support for assigning subtasks, collecting or integrating data, or providing incentives for task performance.

### BRIEF SUMMARY

A method of providing a geo-task campaign, in one aspect, may include receiving a definition of a collective data-gathering activity to be carried out by a plurality of participating respondents, the collective data-gathering activity defined at least by geographic location, time period and activity. The method may also include creating a campaign associated with the collective data-gathering activity according to the definition. The method may further include receiving one or more response values from the plurality of participating respondents, the response values including data that conforms to the defined collective data-gathering activity including a description of the geographic location, a description of the time period, a description of one or more objects at the location associated with the activity. The method may also include coordinating the receiving of said one or more response values during the defined time period and according to the defined geographic location and activity.

A geo-task campaign system, in one aspect, may include a campaign creation module operable to execute on a processor, and further operable to enable a creator of a campaign to define a collective data-gathering activity to be carried out by a plurality of participating respondents, the collective data-gathering activity defined at least by geographic location, time period and activity. An intake module may be operable to receive one or more response values from the plurality of participating respondents, the response values including data that conforms to the defined collective data-gathering activity including a description of the geographic location, a description of the time period, a description of one or more objects at the location associated with the activity. The intake module may be further operable to coordinate receiving of the one or more response values during the defined time period and according to the defined geographic location and activity.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE SEVERAL VIEWS OF THE DRAWINGS

FIG. 1 illustrates a geo-task campaign system in one embodiment of the present disclosure.

FIG. 2 is a screen shot of a user interface of a geo-task campaign system in one embodiment of the present disclosure.

FIG. 3 is a flow diagram illustrating a method of the present disclosure in one embodiment.

FIG. 4 illustrates a schematic of an example computer or processing system that may implement the geo-task campaign system in one embodiment of the present disclosure.

### DETAILED DESCRIPTION

In one embodiment of the present disclosure, a distributed software framework is provided that lets organizations or users define geo-task campaigns that require human intelligence and human action to complete, thus for example addressing the orchestrating of a geo-task campaign.

The framework in one embodiment of the present disclosure supports the definition and/or defining of one or more geo-tasks, and the embedding of those tasks in a campaign. This may involve support for soliciting, signing up, training, coordinating and providing one or more incentives to participants for geo-task campaigns. Geo-tasks in one embodiment of the present disclosure may involve human intelligence tasks, in which at least one of the tasks may have an associated geographical area or location(s). Tasks may be completed using technological devices, and/or manually.

Defining a campaign in one embodiment of the present disclosure may include providing incentives for individuals to perform the tasks. Incentives may be used in various ways, e.g., to encourage higher quality or the completion of multiple instances of a geo-task (thus encouraging the development of expertise). The incentives may include at least paying for task completion in real currency or awarding internal points. Such points may later be redeemed for various prizes, similar to points earned on credit cards, frequent flier miles, and/or others. Or such points may not be redeemable, but may serve simply as a metric of how one individual's performance compares to another's.

Civic participation and human monitoring applications are a class of applications of the software framework of the present disclosure in one embodiment. Examples may include: monitoring the health of Elm trees in a region where Dutch Elm disease is a concern, monitoring the use of bus bike racks, identifying potholes in streets, identifying and physically marking defects in sidewalk paving, noting the presence of invasive species in lakes and rivers, and/or others.

However, the framework is general and not limited to this class of applications. The framework of the present disclosure in one embodiment provides ability for an entity—an individual, a city, state or national government, or a large organization or another—to quickly and easily orchestrate geo-task campaigns, enables them to effectively gather data from a geographic region in a way that may be easy, inexpensive, and transparent. There are also benefits in involving large numbers of ordinary people in such tasks ranging from increased civic engagement to greater perceived legitimacy (e.g., pollution levels monitored by the collective activity of thousands of people may be seen as more trustworthy than monitoring done by a single organization).

The following examples scenarios describe workings of the framework of the present disclosure in one embodiment.

Monitoring Tree Health

In this example, a municipality (referred to as City M) is concerned about the health of the 200,000 Elm trees in the city as Dutch Elm disease is moving into the region. It wants to monitor the health of as many of these trees as possible to control the rate of infection. Thus, it creates a campaign on the framework of the present disclosure with the defined geographic extent being City M and all surrounding municipalities. The campaign includes instructions on how to identify an Elm tree and a simple checklist concerning the appearance of a tree for users to complete. To do a geo-task, a user takes a photograph of the tree (GPS coordinates and timestamp are automatically added by an application running on a smart phone or other device), completes the checklist, and submits the results. The incentive for each completed geo-task is a number of points (e.g., 5 points); those who earn large numbers of points may be featured in the leader-board lists on the framework's central web page.

Bus Bike Rack Monitoring

A metropolitan council wants to get an idea of how much the bike racks on metro transit buses are used. Thus, it defines a campaign in the framework of the present disclosure in one embodiment, instructing users where to go and when, e.g., to go to one of 50 specified bus stops between 7 and 9:30 a.m. or between 3:30 and 6:00 p.m. on April 26. To do a geo-task, users take a photo of the bike rack on a bus (again, GPS coordinates and timestamps are automatically added by a custom application on users' smart phones), fill in a form (bus number, number of used racks), and submit the results. The incentive for each completed geo-task may be provided in real currency, e.g., $0.05 on a MetroTransit Go-To Card.

Monitoring Sidewalk Pavement Quality

In this example, city officials may create a campaign via the framework of the present disclosure to encourage the residents to identify defects in the sidewalk paving in front of their houses, creating safer and more accessible walkways for pedestrians. The city officials may specify the city neighborhoods as the locations for the campaign, and the instructions are to mark defects with spray paint, chalk or other methods, and take and submit photos of the defective sections of sidewalk using a mobile app (application) made available via the framework of the present disclosure in one embodiment. Since the photos are automatically location and time-stamped, the city will be able to determine which neighborhoods have identified the most defects. The incentive may be that the leading neighborhood will be featured on City M's website, along with a collage of photos of the sidewalk defects, and will be given priority in the subsequent sidewalk repair projects.

Detailed Scenario

This scenario shows a framework of the present disclosure being used to orchestrate a campaign designed to populate a public resource—e.g., an interactive map used by Minneapolis-St Paul bicyclists called Cyclopath—with a new set of data points showing the location of bicycle racks. It is noted that the methodologies of the present disclosure provide orchestrating of the campaign to produce a set of data points, e.g., a collective production of a set of geographic data, which may be of use in a wide variety of systems and application domains.

City M's Bicycle Rack Hunt.

A resident (referred to in this example as J) of city M, may create a campaign via the framework of the present disclosure to have people post information about where bike racks could be found. J, for example, may realize that it would be great to share bike rack information, for instance, in a geo-wiki for the city's bicyclists, an editable map where anyone could share information about roads and trails. An example of such a geo-wiki is Cyclopath. To do so, J may use a designated button, e.g., the “Start New Campaign” button in the framework of the present disclosure to design and publicize the bicycle rack hunt campaign. He may fill out a form in the framework of the present disclosure, providing the campaign a name, for instance, may write a sentence describing its purpose, and define the geo-task to be executed. He specifies that each bike rack has a location, a size (number of bikes that can be accommodated), and optionally, a photo. And he defines incentive points associated with doing a geo-task: one point for each bike rack documented, and an extra point for a photo of it. He may recognize that some bike racks will be reported by multiple people.

In the above example, having defined the data to be collected, he defines the campaign. He gives it a start time and an end time, creates some rules (“1. Only real bike racks can be reported—no parking meters, fences, etc., allowed.” “2. Entries for City M only.”), and sets the visibility of the campaign to “public.” Once he saves it, the framework of the present disclosure in one embodiment creates a campaign page for it, and lists it in the calendar of upcoming campaigns on the framework's front page. J takes the URL for the created campaign and publishes it within the system that will end up making use of this data (e.g., geo wiki system), and also puts it in an email that he sends to people or users in his network, asking them to register for the campaign. As they do so, the campaign records the number of registrants and makes it visible on the campaign page. After he posts the campaign URL to a bike organization mailing list, people really start signing up, and this campaign shows up in the list of most popular new campaigns on the framework of the present disclosure's main page. In the meantime, a person he met on a ride has taken a close look at the campaign, and has emailed him to suggest that he modify the data to be collected to include a security tag that rates a bike rack's security as “high”, “medium”, or “low” or “Don't know.” J realizes that this is a good idea, and so he does it. He also gets a note from S, owner of his local bike shop, who says she'll donate tee-shirts as prizes for those who make the final top-10 list—he accepts and adds this to campaign page: it provides good publicity for the campaign, and good publicity for S's shop. The framework of the present disclosure may also provide RSS feeds. Accordingly, J may notice that in addition to the 53 people who have signed up so far, 23 have subscribed to its RSS feed.

Consider in this example also that it is the day before the bicycle hunt campaign. 214 people have signed up. Bowing to popular demand, J extends the scope of the campaign to include other areas, for example, the suburbs of L and H, e.g., after he receives offers of prizes from bike shops in those areas. Using the framework of the present disclosure, J may freeze the campaign definition, e.g., by issuing a command to prevent further changes to the campaign definition. Once the campaign definition is frozen, the framework of the present disclosure can generate a form or application, e.g., that runs on a smartphone or the like, e.g., Android™ and iPhone™. The form or application allows the creation of any number of bike rack data points, each including a location, a size, a security tag, and an optional photo.

The application may also provide users with some feedback on what's going on. For example, the application may provide the user the number of other users participating in the campaign. The user may document some bike racks the user knows about, for example, in the neighborhood: one at the local coffee shop, two at town square, and one in front of a community building, for a total of 8 points. The application may also enable the user to suggest a place for a bike rack. For instance, a user may select or press a button on the application's user interface and take a picture of the area, where the user thinks there ought to be a bike rack. The user may or may not be given points for such suggestion.

As the campaign continues, user J (who created the campaign) may monitor the campaign page via the framework of the present disclosure. For example, J may monitor the number of people that have participated, how many bike rack points have been identified, and what locations they have been reported in. It may happen that while many participants provide reports of bike racks located in City M and Suburb L, there are few reports from Suburb H, and user J may notice this disparity. User J may decide that he would like to encourage participants to look for bike racks in suburb H, and adjust the incentives—in this instance, the number of points offered—to encourage more participants to report bike racks in Suburb H.

Another user, K, who signed up for the bike rack hunt campaign, may be out on a ride. The application on K's smartphone or the like may alert K that double points and/or bonus points are given for reporting bike racks in Suburb H. K may be motivated by the points and may decide to head out to that area.

As user J monitors the campaign page via the framework of the present disclosure, he may notice that some bike rack points are very close to one another. He may decide to inspect the adjacent points and—on the basis of how close they are to one another, or the similarity of their photos, and other information such as their sizes, may decide to merge (or not) bike rack points that are near one another into a single point. A verification flag can be added—requesting that an individual examine the location and verify the number of bike racks at some point in the future—to further clarify whether the reported bike racks are duplicates. Alternatively, J may defer the just-described activity, and instead organize a follow up campaign to carry out this consolidation of adjacent bike rack points.

In the present disclosure, “geo-tasks” refer to human-mediated tasks that may involve going to a specified area or location or set of locations in the physical world, carrying out some action such as sensing some aspect(s) of the physical environment, recording the results, and making those results available to others. Geo-tasks can include actions that affect some aspect(s) of the physical environment in a particular location. Geo-tasks may include other actions that are not geographically linked such as data verification.

In the present disclosure, the term “campaign” is used to describe a collective activity involving the execution of geo-tasks during a particular time period and in a particular location or set of locations.

The term “organization” refers to the entity that creates and manages a campaign in the framework of the present disclosure. An entity may be an individual.

A web site may be provided that runs the framework of the present disclosure in one embodiment. Organizations may navigate to the web site to create campaigns and check on their status. Individuals may navigate to the web site to find out about campaigns and download materials needed to participate in a campaign, e.g., mobile applications and/or printed materials.

Each geo-task may involve taking at least a minimal sense print (e.g., data about an aspect of the environment) or carrying out some other action that is tied to the particular location. This may include taking a photo. This may involve creating a physical mark. It may also involve filling out a form or completing a checklist on a smart phone or other device. If a sense print is taken using the framework's mobile application, a global positioning system (GPS) coordinate and a timestamp will be automatically taken and included with the sense print in one embodiment of the present disclosure. If other sensors such as accelerometers, gyroscopes, ambient light sensors, and microphones are available in the device, data taken from these sensors may be included. Note that if a campaign is completed “manually” rather than with a networked mobile device, a sense print may be manually collected and recorded by an individual, e.g., by writing down observations. In this case, the sense print may be entered later, e.g., at the web site.

The framework of the present disclosure in one embodiment provides an organization creating a campaign with an opportunity to brand it. Thus, for example, when an organization creates a campaign, the organization may use its logos or logos of others to brand the campaign. Each campaign may include a description on the web site such that a potential participant can learn about it, decide whether to participate, and get the required materials.

In creating a campaign, an organization may specify the following in one embodiment of the present disclosure:
The geographic extent for the campaign. This may be a region (e.g., city, metropolitan area, etc.), or a set of points (e.g., all park & ride locations in City M).
The temporal duration of the campaign (where “until closed” is an option).
Termination conditions for the campaign, e.g., the campaign ends when a specified number of sense prints has been entered, when there is at least one sense print for every geographic campaign, or when a specified incentive budget has been used up.
Qualifications for individuals to participate. Examples may include:
   Residency, e.g., open only to residents of City M.
   Age, e.g., must be 18 or older.
Instructions for collecting the sense print, for example:
   Directions to take a photo, e.g., of a tree or bus stop.
   Instructions for examining the environment and entering one's impressions, e.g., “Look at the tree. Describe the texture of the bark.” This could, in general, constitute a tutorial or guide.
   Instructions on how to fill in a form.
Incentive for completing the task. Incentives can be intrinsic or extrinsic. With intrinsic incentives, the participant may receive a direct benefit from completing the task itself such as enjoyment, increased sense of self-worth, or an increased sense of belonging to a community. An extrinsic incentive may a type of reward or payment. The framework of the present disclosure in one embodiment may support at least two types of extrinsic incentives:
   Internal points. These points enable the users of the framework of the present disclosure to compare the amounts of work they performed by comparing the amounts of points they have. The framework of the present disclosure in one embodiment may maintain multiple types of points associated with particular value systems (e.g., “green” points for environmentally-oriented campaigns, and “blue” points for city government campaigns). Points in the present disclosure may act analogously to credit card points or frequent flier miles, in that they could be redeemed for external rewards. If an organization wants to offer points as an incentive, they obtain them, e.g., by purchasing them, from the framework of the present disclosure.
   External rewards. An organization may give participants a type of external reward, e.g., money or discounts or coupons or rebates on utility bills.

The framework of the present disclosure in one embodiment may track internally the performance of all individuals who participate in the system, thus may be able to identify those individuals who are best, even those who are best for certain kinds of tasks. When an organization wants to create a campaign, the organization may be given a choice in the framework, for instance, with extra payment, to be able to target its campaign to individuals with a history of good performance.

The framework of the present disclosure may let organizations choose to run a campaign that use or not use a mobile application. With a campaign that is completed with a mobile application on a networked device, a set of available tasks and associated map for a campaign can be updated in real time as users complete tasks. For example, in the bike rack example, after a desired number of sense prints had been collected at a particular location, that location could be removed from the set of locations for the campaign. The campaign could end automatically once the desired number of sense prints had been collected from the full set of locations.

Campaigns that do not use a mobile networked device, on the other hand, can allow for campaigns in areas (e.g., where there is no cell phone coverage) or by populations (e.g., a girl scout troop) that otherwise would be impossible to include. In this case, there may be several possibilities. (1) Participants will be able to print the materials necessary for a campaign, e.g., maps, instructions, and forms. (2) Organizations will be able to generate materials to send out to people. For example, an organization might choose to send postcards with all the necessary information for identifying and discriminating between healthy and infested Elm trees to a sample of residents of City M.

Non-profit organizations can define campaigns for which they do not have the financial resources to provide incentives. Corporations or individuals who find these campaigns valuable could choose to supply the necessary financial resources.

The framework and its methodology described above enable the definition of a collective data-gathering activity carried out by people and the coordination of the collective performance of that data-gathering activity. Any kind of data may be gathered using the methodology of the present disclosure, the data being related to a particular location and at a particular time. The defining of a collective data-gathering activity may also include defining activity success conditions.

An example top level data structure for defining a collective data-gathering activity may include the following:

<campaign>

<definition-of-activity>

<name-of-activity> -- text string
<description-of-activity> -- textual description (including

instructions) for use by participants

<duration-of-activity> -- one or more time periods during which

the activity takes place

<geographic-scope-of-activity> -- the geographic area or areas

over which the activity takes place
<people-involved-in-activity>

<owners of activity> -- typically the creator(s), and those who

have the ability to edit/alter the activity definition

<registered-participants-in-activity> -- those who sign up
<watchers-of-the-activity> -- those who somehow want to follow

the activity but don't want to participate

<rules-for-activity>

<participant-verification-criteria> --e.g., participants need to meet

certain conditions to participate

<data-verification-criteria> -- data needs to meet certain standards

(completeness, reports by multiple people, etc.) to be accepted as valid

<user-incentive-rules> -- rules that define what sort of incentives

participants receive for doing certain types of actions in the context of the
activity (e.g., 10 points for registering, 5 points for referring another
person who registers and provides data, and 1 point for each data point
reported); rules might also offer incentives for reporting multiple
data points (e.g., a bonus if you report 10 points), or for reporting data
from a particular area or during a particular time period, or for doing
things that result in the validation of already reported data

<activity-success guidelines> -- define minimum criteria for the

success of the data gathering activity over time so that the system can
assist operators in steering (e.g., by offering just-in-time incentives or
otherwise communicating with participants) the activity
<user-gathered-data-definition>

```
<data-location>
  <data-timestamp>
  <data-readings> -- can be anything from a sensor reading (ozone
```

level), multiple-choice question, photo, text entry.

There may be three parts relative to the activity: before, in which a campaign preparation is performed; during, in which campaign management is performed; and after, in which consolidation may be performed. Before the activity, a creator of the campaign may set up or create a new activity definition (e.g., the bike rack hunt) associated with the campaign, and create a web page. Participants may sign up before the activity starts. During this period, people can communicate with the creator and suggest modifications to the activity definition. The creator of the campaign may have an option to sign them up as <owners-of-the-activity> so they can collectively modify it. This is useful because it may result in a better data structure, and because it may make participants feel more involved.

Once the activity begins, the framework of the present disclosure in one embodiment allows the creator and other owners or others to monitor the progress of the activity; it also allows owners to alter the incentives to ensure the most useful data set is being gathered, and that data is being verified.

After the activity ends, the gathered data may be analyzed and used. The framework of the present disclosure may keep a record of participants and the quality of the gathered data so that it can provide (a) a pool of participants to recruit for future activities, with (b) associated information that can allow the computation of expertise and data-quality-reporting metrics for individuals, and (c) enable participants to accumulate incentives across multiple activities or campaigns.

System operators of the framework of the present disclosure may be also enabled to provide access to future campaign organizers information about and/or access to respondents with particular levels of expertise and performance quality vis a vis a particular campaign. For example, system operators may charge campaign organizers for access to respondents, and may charge differentially to provide access to those with higher levels of expertise or performance.

For consolidation, another data structure may be used to hold information about which campaigns a user has participated, which roles the user has played, and how they performed in each role in each campaign. The following is an example of the data structure:

<user-community>

<user-ID><user-contact><campaign-ID><role><role-reputation> --

user has a record for every role in every campaign in which they
participated

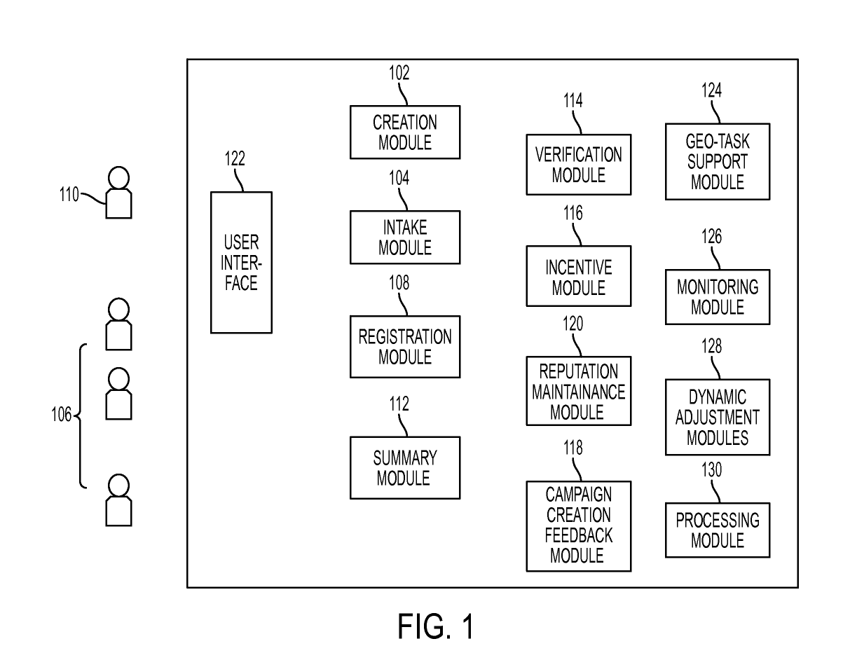

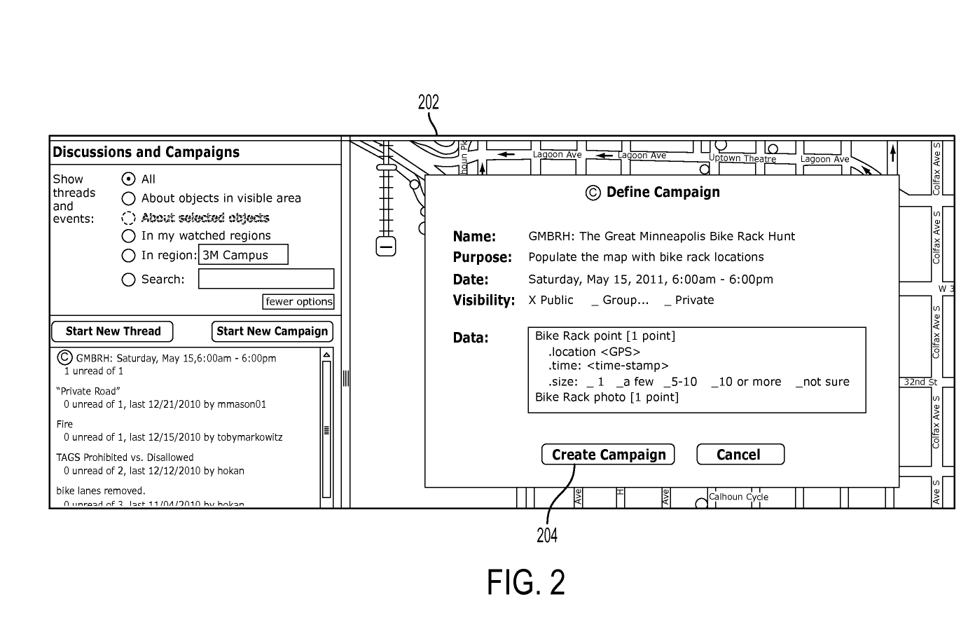

FIG. 1 illustrates a geo-task campaign system in one embodiment of the present disclosure. The system, also referred to herein as a framework, may include one or more functionalities or modules for enabling a campaign creator to define and create a campaign, receive responses from a plurality of respondents, and coordinate the responses according to the requirements set in the definition of the campaign. For instance, a campaign creation module or functionality 102 enables a user (referred to as a creator of a campaign) 110 to define a campaign, a collective data-gathering activity to be carried out by a plurality of participating respondents. A user interface, for example, as shown in FIG. 2, may be displayed on the user's device for creating the campaign. The user defines the collective data-gathering activity defined at least by geographic location, time period and activity, e.g., by entering the appropriate data.

An intake module 104 receives one or more response values from the plurality of participating respondents 106. The response values include data that conforms to the defined collective data-gathering activity. For instance, the plurality of participating respondents 106 may enter as response values a description of the geographic location (e.g., a specific area or location within the geographic location), a description of the time period (e.g., the time the response being entered is observed), a description of one or more objects at the location associated with the activity. The description of the one or more objects may include text description, images, and others. The intake module 104 may also coordinate the receiving of the response values, for instance to the defined time period (e.g., enable receiving of data only during the specified time period) and according to the defined geographic location and activity. A data checking facility may be utilized to verify that the location data entered conforms to (e.g., is within) the defined geographic location and that the description of one or more objects are associated with the defined activity. The intake module 104 may receive one or more response values received via mailing of printed materials, e-mail, a response from an application running on a remote device, an interactive survey, an input to a system database, or response to an interactive voice response system, or combinations thereof.

Geo-task support module 124 may provide those participants who are actively gathering data with support to enable the participants to do so. Support may be in the form of artifacts such as applications, forms, and others. For example, geo-task support module 124 may provide those participants with an application on a smart phone, or a digital or paper-based form, that supports the data collection task. Another example of support may include recording support. For instance, the geo-task support module 124 may provide a means for recording the required data for custom gathering of data. Geo-task support module 124 may also include a training feature. For instance, individuals might require support to enable them to gather appropriate data, or to improve the quality of data they collect. For example, they might be provided with information about how to identify a particular species of tree, or how to identify whether a particular species of tree is likely to have a particular disease. Such support (e.g., artifacts and training) may be made available to participants in the campaign at the time and places they are gathering data. Yet another type of support may be in a form of communication and feedback channel. This type of support provides a communication channel for alerting participants of changes in campaign parameters such as an increase in incentives for gathering data in a particular area, or a lowering of the qualification criteria for participants so as to increase the number of participants.

The system in one embodiment may also include a registration module or functionality 108 that registers the plurality of participating respondents. A summary module or functionality 112 may compile the response values from the plurality of participating respondents, e.g., into a summary.

The collective data-gathering activity or campaign may be defined to include an image, an audio or video recording, a subjective evaluation expressed using a rating scale, an answer to a multiple choice question, a sensor reading, or a qualitative judgment expressed in text or speech, or combinations thereof. Furthermore, the responses may include GPS data. In addition, one or more qualification criteria may be defined for one or more of the respondents to meet. Such qualification criterion may include level of knowledge of the defined collective data-gathering activity, level of knowledge of the location, an age range, a particular expertise, past participation, and/or others. As another example, membership in one or more particular groups may be specified as one or more qualification criteria for the respondents to meet in order for the respondents to participate in the campaign. For example, a defined campaign may need to gather subjective evaluation data from a particular demographic or socio economic group, in which case, the qualification to participate may be restricted to one or more appropriate groups.

A verification module 114 may further check the response values by comparing a first response to one or more second responses produced by different respondents, for instance, to identify duplicate entries by different people. The verification module 114 may also examine the speed with which one or more response values were produced, for instance, to check the validity of the entered data. The verification module 114 may also examine the completeness of data record, analyze data record's internal consistency, and/or compare a response to existing information quality standards.

An incentive module 116 may offer incentives to respondents for providing the response values. In one embodiment, the incentives are dynamically adjusted to modulate the quantity, quality or other characteristics of response values gathered at one or more groups of locations so that the campaign can be successfully completed. For instance, if sense prints are difficult to collect in a particular location, incentives for responses from that location may be increased so as to ensure data is produced for all locations included in the campaign. A reputation maintenance module 120 may maintain a persistent record of quantity, quality and other characteristics of each registered respondent's responses. Incentives may be provided to respondents based on the quality and other characteristics of their responses in a campaign. Access to particular respondents may be provided based on the quality and other characteristics of their responses in previous campaigns. In addition, campaign organizers (creators) may be charged differentially for access to respondents with particular levels of quality and other response characteristics.

A campaign creation feedback module 118 may post one or more activities before the collective data-gathering activity starts wherein one or more of the participating respondents can comment on the defined geographic location, the defined time period or definitions of data associated with the activity, one or more incentives and/or other aspects of the campaign. This module 118 may provide prospective participants with information about the locations, duration and activities in the campaign, and enable the participants to comment on it, based on which the definition of the campaign might be altered and thus improved.

Monitoring module 126 enables users to monitor the data gathering. For example, while the campaign is underway, the creator(s) of the campaign or even participants in general, may be able to monitor the data gathering activity in real time via the functionalities provided in the monitoring module 126. An example type of monitoring may include exploratory monitoring, where monitors can see what is going on—how many participants are active, where data is being reported from, how many responses are being provided per hour, etc. This would help the monitors see the status of the campaign, for example, determine whether the campaign is going well. Another example type of monitoring may be to set automated triggers that might advise monitors that, for instance, no data is being reported from a particular location, or that there are an insufficient number of participants who have a particular level of expertise or reputation.

Dynamic adjustment module 128 may enable the campaign to be altered by dynamically adjusting characteristics of the campaign, for example, so that it is more likely to achieve a successful result. For instance, if an insufficient number of participants are reporting data from a particular campaign area, the incentives for reporting data from that area might be increased, and the participants notified of said increase, for instance, via the communication/feedback channel in the geo-task support module 124. Another response to insufficient quantities of data reports might be to lower the qualifications for participation.

A campaign processing module 130 may process the received data, for instance, by aggregating or merging data that are similar or are duplicates, estimating the reliability of the data, and/or verifying the data. Reliability of the data may be estimated, for instance, based on the information received and previously available information, the source of the data, and other information. Verifying the data may include receiving further information about the data. For example, if a report is received about a pot hole existing in an area where such pot holes usually do not exist, additional information may be requested to further verify the data. As another example, if a reported is pot hole is determined have high cost associated with its repairs, additional data or information may be requested to verify the report.

One or more modules of the framework are operable to run on one or more processors. A user interface module or functionality 122 may receive data and present data from and to the users of the campaign (creators and participants).

FIG. 2 shows a screen snapshot of a user interface in one embodiment of the present disclosure. The display 202 such as shown may be presented to a user. The user may create a campaign by selecting the create campaign button 204, and then specifying other information such as the campaign's name, purposes, and dates, and whether it is public, private, or visible only to a particular group. Part of defining the campaign is defining the type of data to be collected (e.g., a Bike Rack, consisting of a location, time and size), adjunct materials (e.g., a photo), and incentives (e.g., points) associated with gathered data.

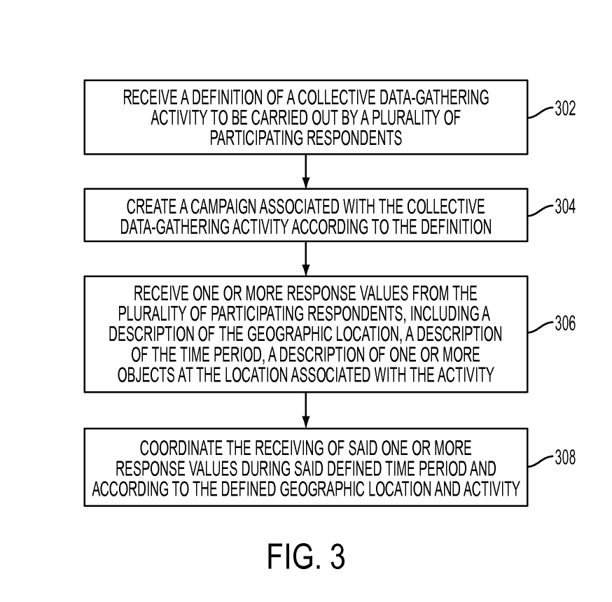

FIG. 3 is a flow diagram illustrating a method of the present disclosure in one embodiment. At 302, a definition of a collective data-gathering activity to be carried out by a plurality of participating respondents is received. For instance, a user creating or starting a campaign may enter the definition. The collective data-gathering activity may be defined at least by geographic location, time period and activity.

At 304, a campaign is created to gather data according to the defined collective data-gathering activity. For instance, a plurality of participants may be enabled to receive information about the campaign, for example, by navigating to a web site, opening an application (e.g., mobile application), and others.

At 306, one or more response values are received from the plurality of participating respondents, the response values including data that conforms to the defined collective data-gathering activity. The responses include a description of the geographic location, a description of the time period, a description of one or more objects at the location associated with the activity. Information such as an image, an audio or video recording, a subjective evaluation expressed using a rating scale, an answer to a multiple choice question, a sensor reading, or a qualitative judgment expressed in text or speech, or combinations thereof, may be also received as responses. Response values may be received by: mailing of printed materials, e-mail, a response from an application running on a remote device, an interactive survey, an input to a system database, or response to an interactive voice response system, or combinations thereof.

At 308, one or more response values received during the defined time period are coordinated. For instance, values may be validated and duplicates may be identified. Reponses may be verified, for example, by comparing a first response to one or more second responses produced by different respondents, examining a speed with which said one or more response values were produced, examining completeness of a data record, analyzing data record's internal consistency, or comparing a response to existing information quality standards, or combinations thereof.

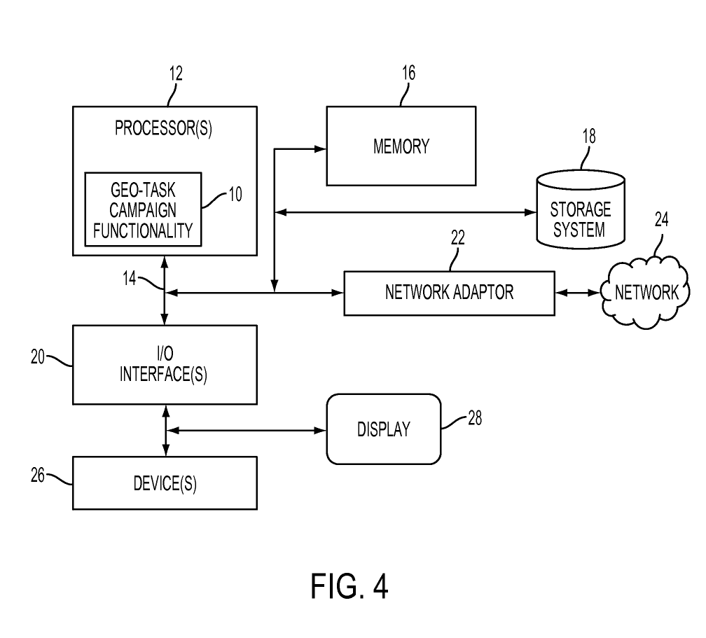

FIG. 4 illustrates a schematic of an example computer or processing system that may implement the geo-task campaign system in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 4 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a geo-task campaign module 10 that performs the methods described herein. The module 10 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages, a scripting language such as Perl, VBS or similar languages, and/or functional languages such as Lisp and ML and logic-oriented languages such as Prolog. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The computer program product may comprise all the respective features enabling the implementation of the methodology described herein, and which—when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

We claim:

1. A geo-task campaign system, comprising:
a processor;
a campaign creation module operable to execute on the processor, and further operable to enable a creator of a campaign to define a collective data-gathering activity to be carried out by a plurality of participating respondents, the collective data-gathering activity defined at least by geographic location, time period and activity; and
an intake module operable to receive one or more response values from the plurality of participating respondents, the response values including data that conforms to the defined collective data-gathering activity including a description of the geographic location, a description of the time period, a description of one or more objects at the location associated with the activity, the intake module further operable to coordinate receiving of said one or more response values during said defined time period and according to the defined geographic location and activity.

2. The system of claim 1, further including:
a processing module operable to process the collective data-gathering activity.

3. The system of claim 2, wherein the processing module is operable to estimate reliability of the one or more response values, aggregate the response values, or verify the response values.

4. The system of claim 1, wherein the collective data-gathering activity is defined to include an image, an audio or video recording, a subjective evaluation expressed using a rating scale, an answer to a multiple choice question, a sensor reading, or a qualitative judgment expressed in text or speech, or combinations thereof.

5. The system of claim 1, wherein said one or more of the respondents are those that meet one or more qualification criteria.

6. The system of claim 1, further including:
a support module operable to provide the participating respondents with support for gathering the data, the support including artifacts, training, and communication and feedback channel;
a verification module operable to verify one or more of the response values by comparing a first response to one or more second responses produced by different respondents, by examining a speed with which said one or more response values were produced, by examining completeness of a data record, by analyzing data record's internal consistency, or by comparing a response to existing information quality standards, or combinations thereof;
an incentive module operable to offer incentives for providing a response, wherein the incentives are dynamically adjusted to modulate quantity, quality or other characteristics of the response values gathered at one or more groups of locations;
a registration module operable to register the plurality of participating respondents;
a summary module operable to compile said response values from the plurality of participating respondents;
a monitoring module operable to enable the creator and the plurality of participating respondents to monitor in real time gathering of the data; or
a dynamic adjustment module operable to enable the campaign to be altered by dynamically adjusting characteristics of the campaign;
a campaign creation feedback module operable to post one or more activities before the collective data-gathering activity starts wherein one or more of the participating respondents can comment on the defined geographic location, the defined time period or definitions of data associated with the activity, one or more incentives or combinations thereof; or
a reputation maintenance module operable to maintain a persistent record of quantity, quality and other characteristics of each registered respondent's responses; or
combinations thereof.

7. The system of claim 6, wherein incentives are provided to said plurality of participating respondents based on the quantity, quality and other characteristics of their responses.

8. The system of claim 7, wherein said creator is charged differently for access to respondents with particular levels of quality and other response characteristics.

9. The system of claim 1, wherein the intake module receives one or more response values by: mailing of printed materials, e-mail, a response from an application running on a remote device, an interactive survey, an input to a system database, or response to an interactive voice response system, or combinations thereof.

10. The system of claim 1, wherein the one or more response values further includes GPS location data.

11. A method of providing a geo-task campaign, comprising:
receiving a definition of a collective data-gathering activity to be carried out by a plurality of participating respondents, the collective data-gathering activity defined at least by geographic location, time period and activity;
creating, by a processor, a campaign associated with the collective data-gathering activity according to the definition;
receiving one or more response values from the plurality of participating respondents, the response values including data that conforms to the defined collective data-gathering activity including a description of the geographic location, a description of the time period, a description of one or more objects at the location associated with the activity; and
coordinating the receiving of said one or more response values during said defined time period and according to the defined geographic location and activity.

12. The method of claim 11, further including processing the collective data-gathering activity.

13. The method of claim 12, wherein the processing includes estimating reliability of the one or more response values, aggregating the response values, or verifying the response values, or combinations thereof.

14. The method of claim 11, further including verifying one or more of the response values by: comparing a first response to one or more second responses produced by different respondents, examining a speed with which said one or more response values were produced, examining completeness of a data record, analyzing data record's internal consistency, or comparing a response to existing information quality standards, or combinations thereof.

15. The method of claim 11, further including providing the participating respondents with support for gathering the data, the support including artifacts, training, and communication and feedback channel.

16. The method of claim 11, further including enabling the creator and the plurality of participating respondents to monitor in real time gathering of the data.

17. The method of claim 11, further including enabling the campaign to be altered by dynamically adjusting one or more characteristics of the campaign.

18. The method of claim 11, further including enabling posting of one or more activities before the collective data-gathering activity starts wherein one or more of the participating respondents can comment on the defined geographic location, the defined time period or definitions of data associated with the activity, one or more incentives or combinations thereof.

19. The method of claim 11, further including:
registering the plurality of participating respondents to the campaign;
maintaining a persistent record of quantity, quality and other characteristics of each registered respondent's responses; or
compiling said response values from the plurality of participating respondents; or
combinations thereof.

20. The method of claim 11, wherein the collective data-gathering activity is defined to include an image, an audio or video recording, a subjective evaluation expressed using a rating scale, an answer to a multiple choice question, a sensor reading, or a qualitative judgment expressed in text or speech, or combinations thereof.

21. The method of claim 11, wherein the one or more response values are received by: mailing of printed materials, e-mail, a response from an application running on a remote device, an interactive survey, an input to a system database, or response to an interactive voice response system, or combinations thereof.

22. A computer readable storage medium storing a program of instructions executable by a machine to perform a method of providing a geo-task campaign, comprising:
receiving a definition of a collective data-gathering activity to be carried out by a plurality of participating respondents, the collective data-gathering activity defined at least by geographic location, time period and activity;
creating a campaign associated with the collective data-gathering activity according to the definition;
receiving one or more response values from the plurality of participating respondents, the response values including data that conforms to the defined collective data-gathering activity including a description of the geographic location, a description of the time period, a description of one or more objects at the location associated with the activity; and
coordinating the receiving of said one or more response values during said defined time period and according to the defined geographic location and activity.

23. The computer readable storage medium of claim 22, further including processing the collective data-gathering activity.

24. The computer readable storage medium of claim 22, wherein the processing includes estimating reliability of the one or more response values, aggregating the response values, or verifying the response values, or combinations thereof.

25. The computer readable storage medium of claim 22, further including:
registering the plurality of participating respondents to the campaign;
compiling said response values from the plurality of participating respondents;
verifying one or more of the response values by: comparing a first response to one or more second responses produced by different respondents, examining a speed with which said one or more response values were produced, examining completeness of a data record, analyzing data record's internal consistency, or comparing a response to existing information quality standards, or combinations thereof;
providing the participating respondents with support for gathering the data, the support including artifacts, training, and communication and feedback channel;
enabling the creator and the plurality of participating respondents to monitor in real time gathering of the data;
enabling the campaign to be altered by dynamically adjusting one or more characteristics of the campaign;
enabling posting of one or more activities before the collective data-gathering activity starts wherein one or more of the participating respondents can comment on the defined geographic location, the defined time period or definitions of data associated with the activity, one or more incentives or combinations thereof; or
maintaining a persistent record of quantity, quality and other characteristics of each registered respondent's responses; or
combinations thereof.
